(19) United States
(12) Patent Application Publication
(10) Pub. No.: US 2024/0349100 A1
(43) Pub. Date: Oct. 17, 2024

(54) MEASUREMENT EVALUATION PERIODS FOR SIDELINK SYNCHRONIZATION SIGNALS FROM SYNCHRONIZATION REFERENCE SOURCES

(71) Applicant: QUALCOMM Incorporated, San Diego, CA (US)

(72) Inventors: Chu-Hsiang HUANG, San Diego, CA (US); Chih-Hao LIU, San Diego, CA (US); Jae Ho RYU, San Diego, CA (US)

(21) Appl. No.: 18/417,524

(22) Filed: Jan. 19, 2024

Related U.S. Application Data
(60) Provisional application No. 63/496,316, filed on Apr. 14, 2023.
(60) Provisional application No. 63/502,016, filed on May 12, 2023.

(51) Int. Cl. H04W 24/10; H04L 5/00; H04W 72/40

(52) U.S. Cl. CPC H04W 24/10; H04L 5/0058; H04W 72/40

(57) ABSTRACT

Various aspects of the present disclosure generally relate to wireless communication. In some aspects, a user equipment (UE) may determine whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available. The UE may perform an initiation or a cease of an SLSS transmission of the UE based at least in part on whether the SLSS is received from SyncRef UE during the measurement evaluation period. Numerous other aspects are described.

### CROSS-REFERENCE TO RELATED APPLICATION

This Patent Application claims priority to U.S. Provisional Patent Application Nos. 63/496,316 filed on Apr. 14, 2023 and 63/502,016 filed on May 12, 2023, both of which are entitled “MEASUREMENT EVALUATION PERIODS FOR SIDELINK SYNCHRONIZATION SIGNALS FROM SYNCHRONIZATION REFERENCE SOURCES,” and assigned to the assignee hereof. The disclosure of the prior Applications are considered part of and are incorporated by reference into this Patent Application.

### FIELD OF THE DISCLOSURE

Aspects of the present disclosure generally relate to wireless communication and to techniques and apparatuses for measurement evaluation periods for sidelink synchronization signals (SLSSs) from synchronization reference sources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes one or more memories; and one or more processors, coupled to the one or more memories, which, individually or in any combination, are operable to cause the apparatus to: determine whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available; and perform an initiation or a cease of an SLSS transmission of the UE based at least in part on whether the SLSS is received from SyncRef UE during the measurement evaluation period.

In some implementations, a method of wireless communication performed by a UE includes determining whether an SLSS is received from a SyncRef UE during a measurement evaluation period, the measurement evaluation period being based at least in part on a quantity of S-SSB periods in which the SLSS from the SyncRef UE is not available; and performing an initiation or a cease of an SLSS transmission of the UE based at least in part on whether the SLSS is received from SyncRef UE during the measurement evaluation period.

In some implementations, a non-transitory computer-readable medium storing a set of instructions for wireless communication includes one or more instructions that, when executed by one or more processors of a UE, cause the UE to: determine whether an SLSS is received from a SyncRef UE during a measurement evaluation period, the measurement evaluation period being based at least in part on a quantity of S-SSB periods in which the SLSS from the SyncRef UE is not available; and perform an initiation or a cease of an SLSS transmission of the UE based at least in part on whether the SLSS is received from SyncRef UE during the measurement evaluation period.

In some implementations, an apparatus for wireless communication includes means for determining whether an SLSS is received from a SyncRef apparatus during a measurement evaluation period, the measurement evaluation period being based at least in part on a quantity of S-SSB periods in which the SLSS from the SyncRef apparatus is not available; and means for performing an initiation or a cease of an SLSS transmission of the apparatus based at least in part on whether the SLSS is received from SyncRef apparatus during the measurement evaluation period.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-5 are diagrams illustrating examples associated with measurement evaluation periods for sidelink synchronization signals (SLSSs) from synchronization reference sources, in accordance with the present disclosure.

FIG. 6 is a diagram illustrating an example process associated with measurement evaluation periods for SLSSs from synchronization reference sources, in accordance with the present disclosure.

FIG. 7 is a diagram of an example apparatus for wireless communication, in accordance with the present disclosure.

### DETAILED DESCRIPTION

In a sidelink unlicensed (SL-U), a synchronization reference (SyncRef) user equipment (UE) may serve as a synchronization reference source for a UE. However, the SyncRef UE may be unable to transmit a sidelink synchronization signal (SLSS) to the UE due to a listen-before-talk (LBT) failure. The UE may not be able to measure or detect the SyncRef UE within a measurement evaluation period when the SLSS is not available due to the LBT failure. Without receiving the SLSS, the UE may be unable to derive a transmission timing for a sidelink data transmission, which may degrade a performance of the UE.

Various aspects relate generally to SL-U measurement requirements. Some aspects more specifically relate to measurement evaluation periods for SLSSs from synchronization reference sources. In some examples, a UE may determine whether an SLSS is received from a SyncRef UE during a measurement evaluation period. The measurement evaluation period may be based at least in part on a quantity of sidelink synchronization signal block (S-SSB) periods in which the SLSS from the SyncRef UE is not available. The measurement evaluation period may correspond to a default quantity of S-SSB periods (e.g., four S-SSB periods) plus the quantity of S-SSB periods in which the SLSS from the SyncRef UE is not available. The evaluation measurement period may be an extended evaluation measurement period when the SLSS from the SyncRef UE (or multiple SyncRef UEs) is not available (e.g., due to an LBT failure at the SyncRef UE). The UE may perform an initiation or a cease of an SLSS transmission of the UE (e.g., the UE's own SLSS transmission) based at least in part on whether the SLSS is received from SyncRef UE during the measurement evaluation period.

Particular aspects of the subject matter described in this disclosure may be implemented to realize one or more of the following potential advantages. In some examples, when the SyncRef UE is unable to transmit the SLSS (e.g., due to the LBT failure at the SyncRef UE), the UE may still be able to make a decision regarding whether to initiate its own SLSS transmission (which may aid another UE for a synchronization) or whether to cease its own SLSS transmission (e.g., the SLSS transmission from the UE may not be needed when the SyncRef UE is already providing an SLSS). The extended evaluation measurement period may provide the SyncRef UE with additional time to transmit the SLSS, which may prevent the UE from unnecessarily initiating or ceasing its own SLSS transmission. As a result, the extended evaluation measurement period may improve a performance of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

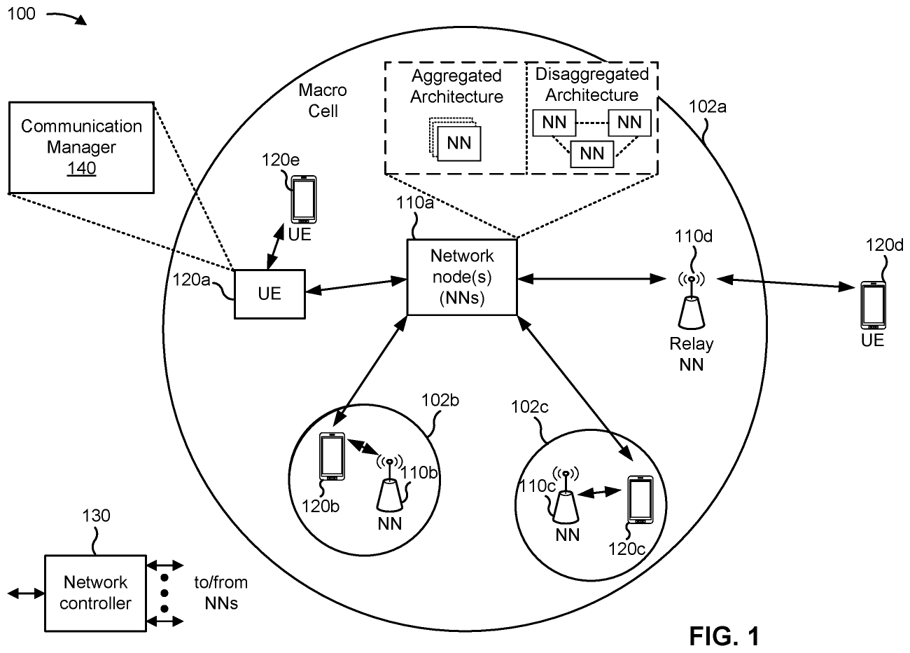

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may determine whether an SLSS is received from a SyncRef UE during a measurement evaluation period, the measurement evaluation period being based at least in part on a quantity of S-SSB periods in which the SLSS from the SyncRef UE is not available; and perform an initiation or a cease of an SLSS transmission of the UE based at least in part on whether the SLSS is received from SyncRef UE during the measurement evaluation period. Additionally, or alternatively, the communication manager 140 may perform one or more other operations described herein.

As indicated above, FIG. 1 is provided as an example. Other examples may differ from what is described with regard to FIG. 1.

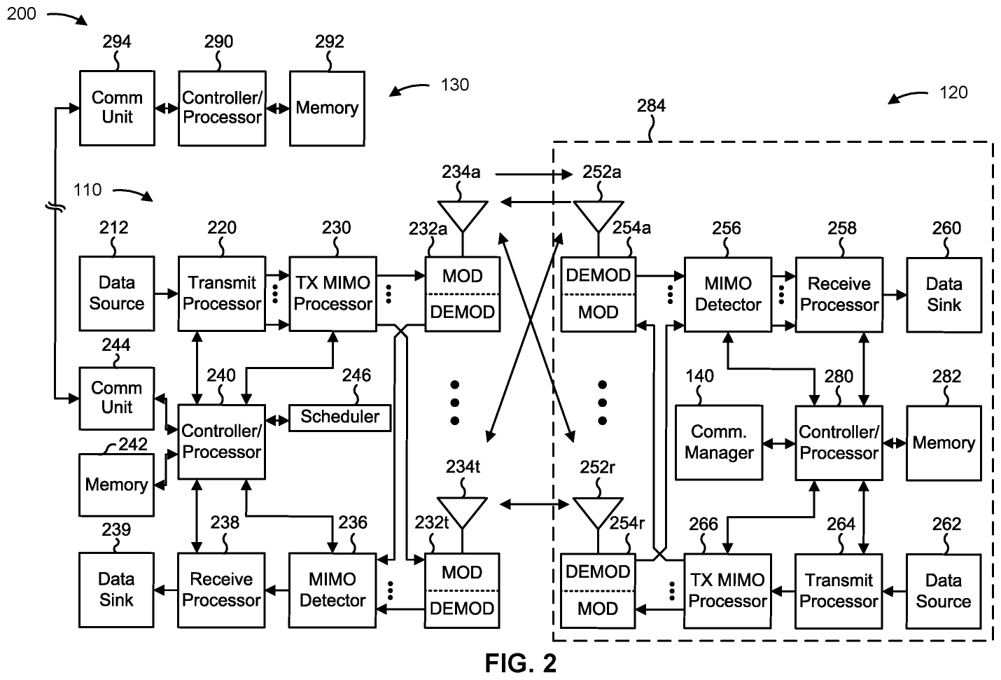

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

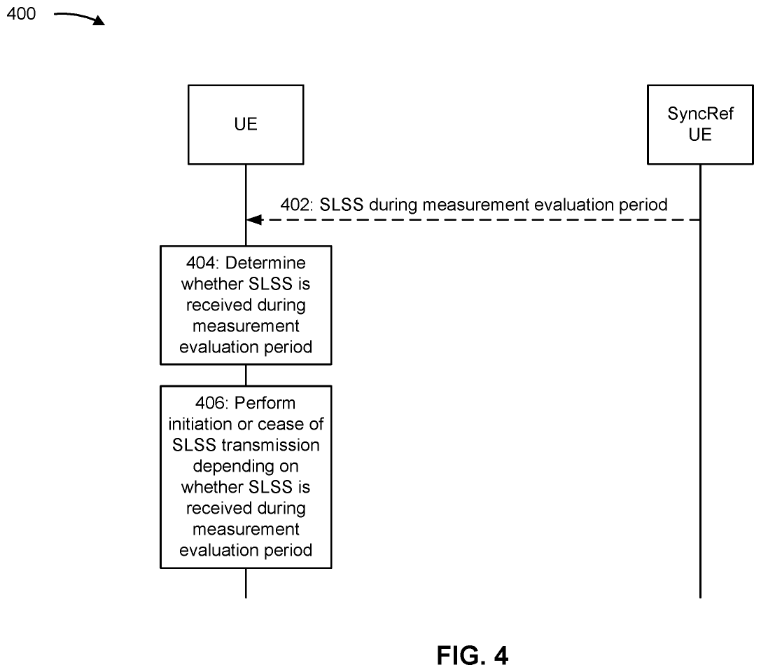

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

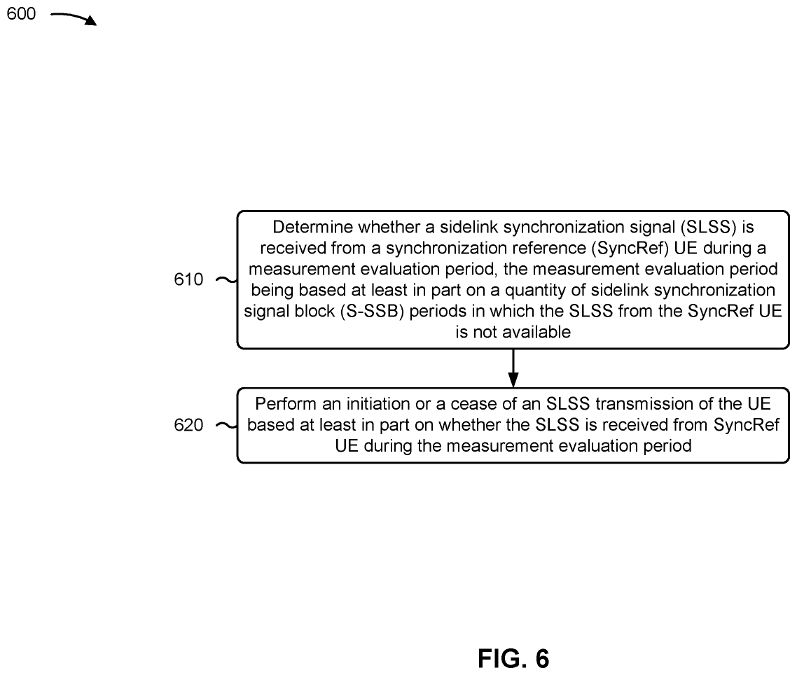

The controller/processor 240 of the network node 110, the controller/processor 280 of the UE 120, and/or any other component(s) of FIG. 2 may perform one or more techniques associated with measurement evaluation periods for SLSSs from synchronization reference sources, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, and/or other processes as described herein. In some examples, executing instructions may include running the instructions, converting the instructions, compiling the instructions, and/or interpreting the instructions, among other examples.

In some aspects, a UE (e.g., the UE 120) includes means for determining whether an SLSS is received from a SyncRef UE during a measurement evaluation period, the measurement evaluation period being based at least in part on a quantity of S-SSB periods in which the SLSS from the SyncRef UE is not available; and/or means for performing an initiation or a cease of an SLSS transmission of the UE based at least in part on whether the SLSS is received from SyncRef UE during the measurement evaluation period. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

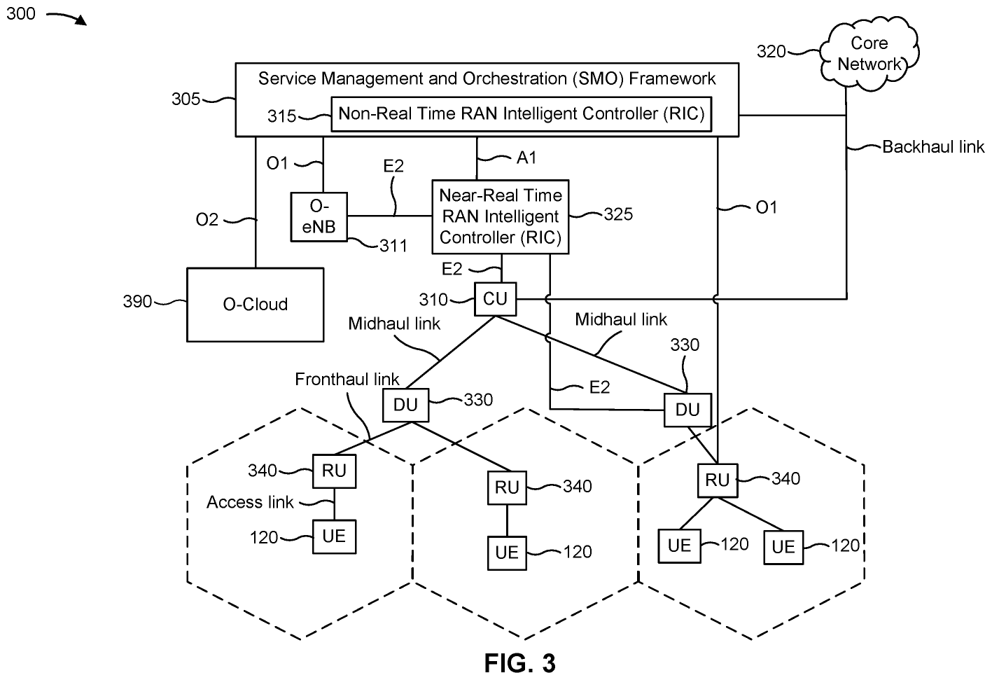

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A UE (e.g., a sidelink UE) may be capable of V2X sidelink transmissions. A transmission timing (or reference timing) for a V2X sidelink transmission by the UE may be based at least in part on a synchronization reference source. The synchronization reference source may be a global navigation satellite system (GNSS), but in some cases, the GNSS may not be available. The synchronization reference source may be a SyncRef UE (e.g., another UE that acts as the synchronization reference source). The transmission timing used for the V2X sidelink transmission may be based at least in part on an SLSS (or an S-SSB) received from the SyncRef UE. The UE may be in a cell selection state (e.g., any cell selection state). The UE may be out of coverage on a V2X sidelink carrier, and the UE may be associated with a serving cell on a non-V2X sidelink carrier. The UE may be in coverage with a serving cell on an NR V2X sidelink carrier. The UE may be capable of measuring a physical sidelink broadcast channel (PSBCH)-RSRP of a selected SyncRef UE used as the synchronization reference source. The UE may measure the PSBCH-RSRP associated with the SLSS transmitted by the SyncRef UE. The UE may evaluate the PSBCH-RSRP to initiate or cease its own SLSS transmission within a time period. The time period may be an SLSS evaluation period (T_{evaluate,SLSS}) (in ms), which may equal four S-SSB periods.

The UE may be configured to perform two tasks at the same time. In a first task, the UE may search for the SyncRef UE and may then receive the SLSS from the SyncRef UE. The UE may use the SLSS received from the SyncRef UE for the V2X sidelink transmission. In a second task, the UE may also act as a SyncRef UE. In this case, the UE may transmit its own SLSS to another UE that is using the UE as the synchronization reference source.

The UE may measure its SyncRef UE to decide whether to initiate or cease its own SLSS transmission. The UE may measure the PSBCH-RSRP associated with the SLSS transmitted by the SyncRef UE. The UE may determine, based on the measured PSBCH-RSRP, whether to initiate or cease its own SLSS transmission. When the measured PSBCH-RSRP is relatively strong, the UE may not transmit its own SLSS transmission. When the measured PSBCH-RSRP is relatively weak, the UE may transmit its own SLSS transmission to extend a coverage. The UE may determine the measured PSBCH-RSRP within a measurement evaluation period (or SLSS evaluation period). The measurement evaluation period may be four S-SSB periods or four discontinuous reception (DRX) cycles when the SyncRef UE is the synchronization reference source. The UE may be required to measure the PSBCH-RSRP to decide whether to initiate or cease its own SLSS transmission within the measurement evaluation period.

The UE may search for new detectable SyncRef UE when the SyncRef UE (e.g., an original SyncRef UE that serves as the synchronization reference source for the UE) is directly or indirectly synchronized to a GNSS. The UE may not drop a V2X transmission for the purpose of selection or reselection to the SyncRef UE. The UE may be able to identify a newly detectable intra-frequency SyncRef UE within T_{detect,SyncRef UE_V2X} seconds when the SyncRef UE meets a selection or reselection criterion, where T_{detect,SyneRef UE_V2X} is defined as 1.6 seconds at S-SSB Ês/Iot≥0 dB, provided that the UE is allowed to drop a maximum of 30% of its SLSS transmissions during T_{detect,SyncRef UE_V2X} for the purpose of selection or reselection to the SyncRef UE. Here, a signal-to-noise ratio (SNR) may also be referred to as Ês/Iot.

In an SL-U, the SyncRef UE may not be able to transmit the SLSS due to an LBT failure. The SyncRef UE may be allowed to transmit the SLSS on additional candidate locations in case of LBT failure. For example, the SyncRef UE may be allowed to transmit S-SSBs on additional S-SSB candidate locations, with respect to S-SSB occasions, in case of LBT failures. Data may or may not be transmitted on these additional S-SSB candidate locations. The UE may not be able to measure or detect SyncRef UE(s) within the measurement evaluation period when SLSSs are not available due to LBT failure, even with the additional S-SSB candidate locations. Whether the SLSSs from the SyncRef UE(s) are available to the UE may depend on which slots are measured by the UE. The UE may be unable to measure a synchronization reference source to decide whether to initiate or cease its own SLSS transmission, even though the UE may be required to measure the PSBCH-RSRP within the measurement evaluation period. Further, the UE may be unable to search for a newly detectable SyncRef UE. Without receiving the SLSS, the UE may be unable to perform V2X sidelink data transmissions, or the UE may perform V2X sidelink data transmissions with an incorrect transmission timing, thereby degrading a performance of the UE (as well as a UE that is supposed to receive the V2X sidelink data transmission).

The UE may measure the SLSS from the SyncRef UE, and the UE may start its own SLSS transmission, based at least in part on the SLSS from the SyncRef UE being relatively weak (e.g., a PSBCH-RSRP associated with the SLSS satisfies a threshold). The UE may determine whether to initiate or cease its own SLSS transmission when the SyncRef UE is the synchronization reference signal, but the SLSS may not always be available from the SyncRef UE. In SL-U, when the SyncRef UE experiences LBT failures for SLSS transmissions (or S-SSB transmissions), a UE-initiating SLSS transmission (e.g., an SLSS transmission that is transmitted by the UE) may be beneficial to keep an SL-U UE cluster synchronized.

In various aspects of techniques and apparatuses described herein, a UE may determine whether an SLSS is received from a SyncRef UE during a measurement evaluation period. The measurement evaluation period may be based at least in part on a quantity of S-SSB periods in which the SLSS from the SyncRef UE is not available. The measurement evaluation period may correspond to a default quantity of S-SSB periods (e.g., four S-SSB periods) plus the quantity of S-SSB periods in which the SLSS from the SyncRef UE is not available. The evaluation measurement period may be an extended evaluation measurement period when the SLSS from the SyncRef UE (or multiple SyncRef UEs) is not available (e.g., due to an LBT failure at the SyncRef UE). The UE may perform an initiation or a cease of an SLSS transmission of the UE (e.g., the UE's own SLSS transmission) based at least in part on whether the SLSS is received from SyncRef UE during the measurement evaluation period. The UE may perform an SLSS transmission decision (e.g., initiate its own SLSS transmission or cease its own SLSS transmission) in the presence of measurement occasions without an available SLSS from the SyncRef UE. As a result, when the SyncRef UE is unable to transmit the SLSS (e.g., due to the LBT failure at the SyncRef UE), the UE may still be able to make a decision regarding whether to initiate its own SLSS transmission (which may aid another UE for a synchronization) or whether to cease its own SLSS transmission (e.g., the SLSS transmission from the UE may not be needed when the SyncRef UE is already providing an SLSS). The extended evaluation measurement period may provide the SyncRef UE with additional time to transmit the SLSS, which may prevent the UE from unnecessarily initiating or ceasing its own SLSS transmission. As a result, the extended evaluation measurement period may improve a performance of the UE.

In some aspects, in an NR unlicensed operation, when a synchronization signal block (SSB) is unavailable in a synchronization signal (SS)/physical broadcast channel (PBCH) (SS/PBCH) block measurement timing configuration (SMTC) period (e.g., an SSB period in a search/measurement), the UE may extend a search window and keep searching in an extended period to account for an SMTC period without available SSBs. However, in a sidelink unlicensed operation, the UE may be half-duplex and an additional search in the extended period may lead to dropping additional SLSS transmissions. In some aspects, to keep a dropping rate of SLSS transmissions the same, instead of extending the search window and performing the search in the extended window (and dropping all the SLSS transmissions in the extended window), whenever an unavailable S-SSB period is present within the search window, the UE may start a new search window and keep the same dropping rate within the search window to detect a new source. In the extended window, the UE may need to perform the search and drop all the SLSS transmissions within the extension. On the other hand, when the new search window is started, the UE may only search in three out of ten S-SSB periods, which may keep the dropping rate down.

In some aspects, when the UE is synchronized to the SyncRef UE that is synchronized to GNSS directly or indirectly, the UE may be able to identify a newly detectable intra-frequency SyncRef UE within T_{detect,SyneRef UE_V2X_CCA} seconds when the SyncRef UE meets selection/reselection criterion and all S-SSB periods selected for SyncRefUE identification are available during the T_{detect,SyncRef UE_V2X_CCA} seconds. In some aspects, the UE may be allowed to additionally drop a maximum of 30% of its SLSS transmission. The UE may be able to identify the newly detectable intra-frequency SyncRef UE within T′_{detect,SyneRef UE_V2X_CCA} seconds when the SyncRef UE is in the UE's S-SSB resource, and all S-SSB periods selected for SyncRefUE identification are available during the T′_{detect,SyneRef UE_V2X_CCA} seconds, only when the UE additionally drops a maximum of 30% of its SLSS transmission. Further, T′_{detect,SyncRef UE_V2X_CCA} may be defined as 1.6 seconds at S-SSB Ês/Iot≥0 dB.

FIG. 4 is a diagram illustrating an example 400 associated with measurement evaluation periods for SLSSs from synchronization reference sources, in accordance with the present disclosure. As shown in FIG. 4, example 400 includes communication between a UE (e.g., UE 120a) and a SyncRef UE (e.g., UE 120e). In some aspects, the UE and the SyncRef UE may be included in a wireless network, such as wireless network 100.

As shown by reference number 402, the UE may (or may not) receive an SLSS (or S-SSB) from the SyncRef UE during a measurement evaluation period. The SyncRef UE may serve as a synchronization reference source for the UE. The SLSS may include a sidelink primary synchronization signal (S-PSS) and a sidelink secondary synchronization signal (S-SSS).

As shown by reference number 404, the UE may determine whether the SLSS is received from the SyncRef UE during the measurement evaluation period. The measurement evaluation period may be based at least in part on a quantity of S-SSB periods in which the SLSS from the SyncRef UE is not available. For example, the SLSS from the SyncRef UE may not be available during the quantity of S-SSB periods due to an LBT failure associated with the SyncRef UE (which may prevent the SyncRef UE from transmitted the SLSS). The measurement evaluation period may correspond to a default quantity of S-SSB periods (e.g., four S-SSB periods) plus the quantity of S-SSB periods in which the SLSS from the SyncRef UE is not available. The quantity of S-SSB periods in which the SLSS from the SyncRef UE is not available may be associated with a maximum quantity (X_na). The maximum quantity may be a fixed value or may be configured via RRC signaling from a network node.

In some aspects, for an SL-U measurement requirement on an SLSS evaluation and search, an S-SSB period in which the SLSS from the SyncRef UE is not available may be referred to as an unavailable S-SSB period. The maximum quantity of unavailable S-SSB periods (X_na) may be defined in the measurement evaluation period. A measurement evaluation period requirement may be equal to four S-SSB periods plus the quantity (x) of S-SSB periods (e.g., (4+x) S-SSB periods), where x is the quantity of unavailable S-SSB periods and x≤X_na, such that X_na is an upper bound on the quantity of unavailable S-SSB periods. The measurement evaluation period may be greater than four S-SSB periods (as in a past approach), depending on the quantity of unavailable S-SSB periods (e.g., the quantity of S-SSB periods during which no SLSS is received from the SLSS).

As shown by reference number 406, the UE may perform an initiation or a cease of an SLSS transmission of the UE based at least in part on whether the SLSS is received from SyncRef UE during the measurement evaluation period. In some aspects, the UE may receive the SLSS from the SyncRef UE during the measurement evaluation period. In this case, the UE may perform the initiation or the cease of the SLSS transmission of the UE based at least in part on a measurement (e.g., a PSBCH-RSRP measurement) associated with the SLSS received from the SyncRef UE. In some aspects, the UE may not receive the SLSS from the SyncRef UE during the measurement evaluation period. In this case, the UE may perform the initiation of the SLSS transmission of the UE based at least in part on the SLSS not being received from the SyncRef UE during the measurement evaluation period.

In some aspects, before reaching X_na unavailable S-SSB periods, the initiation or the cease of an SLSS transmission decision by the UE may be based at least in part on a collected measurement associated with the SLSS received from the SyncRef UE. After reaching the X_na unavailable S-SSB periods, the UE may initiate an SLSS transmission. The UE may initiate its own SLSS transmission, even though the UE did not receive the SLSS from the SyncRef UE within the (4+x) S-SSB periods. The UE may initiate its own SLSS transmission because the lack of the SLSS from the SyncRef UE may be indicative that the SyncRef UE is associated with an LBT failure or that an SLSS transmitted by the SyncRef UE is relatively weak and undetectable by the UE, and thus the UE should initiate its own SLSS transmission to extend a coverage by assisting other UEs with synchronization. Further, X_na may be a fixed value or may be configured by a network node via RRC signaling.

In some aspects, after reaching the X_na unavailable S-SSB periods, the UE may initiate the SLSS transmission when the SyncRef UE is available as a current synchronization source for the UE (even though the SyncRef may be associated with LBT failure). The SyncRef UE may not be available at the UE in SL-U when a first x successive candidate S-SSB positions in every S-SSB period are not available during a last y ms. Otherwise, the SyncRef UE may be considered as available at the UE in SL-U. After reaching the X_na unavailable S-SSB periods, the UE may not initiate the SLSS transmission when the SyncRef UE is not available as the current synchronization source for the UE. In some aspects, the initiation of the SLSS transmission of the UE may be based at least in part on the SyncRef UE being available as the current synchronization source for the UE.

In some aspects, the SyncRef UE may be a first SyncRef UE, and the UE may detect a second SyncRef UE within a time period when the measurement associated with the SLSS received from the first SyncRef UE satisfies a condition. The UE may be permitted to drop a maximum percentage of SLSS transmissions of the UE during the time period for the purpose of the detection of the second SyncRef UE, and then for the selection/reselection to the second SyncRef UE. The time period and the maximum percentage may be based at least in part on the quantity of S-SSB periods in which the SLSS from the SyncRef UE is not available. The maximum percentage may be associated with a maximum dropping rate constraint. The UE may search additional S-SSB candidate locations for detecting the second SyncRef UE based at least in part on a signal quality associated with the SLSS received from the first SyncRef UE. The signal quality may be based at least in part on the SLSS being associated with a measurement that satisfies a first threshold, or the signal quality may be based at least in part on the quantity of S-SSB periods in which the SLSS from the SyncRef UE is not available satisfying a second threshold. The UE may drop data transmissions associated with the additional S-SSB candidate locations. The UE may refrain from searching additional S-SSB candidate locations based at least in part on a signal quality associated with the SLSS received from the first SyncRef UE.

In some aspects, the UE may search for the second SyncRef UE, such as a new detectable SyncRef UE, with unavailable S-SSB periods. The UE may be able to identify a newly detectable intra-frequency SyncRef UE within (1.6+y1) seconds when an S-SSB Ês/Iot≥0 dB, provided that the UE is allowed to drop a maximum of (30+y2) % of its SLSS transmissions during the (1.6+y1) seconds for the purpose of selection or reselection to the SyncRef UE. The values of y1 and y2 may be based on the quantity of unavailable S-SSB periods, and may be subject to maximum value constraints, and y2 may also be subject to the maximum dropping rate constraint. Additional SLSS slots may be monitored when defining unavailable S-SSB periods.

In some aspects, the UE may search for the second SyncRef UE, such as a new detectable SyncRef UE, with unavailable S-SSB periods. The UE may be able to identify a newly detectable intra-frequency SyncRef UE within (1.6+1.6*x) seconds when an S-SSB Ês/Iot≥0 dB, provided that the UE is allowed to drop a maximum of 30% of its SLSS transmissions during the (1.6+1.6*x) seconds for the purpose of selection or reselection to the SyncRef UE. The value x may be the number of 1.6 second detection windows with at least one unavailable S-SSB period in three selected S-SSB periods for S-SSB detection, and a selection associated with the three S-SSB periods in the 1.6 second detection window may be based at least in part on a UE implementation. Additional SLSS slots may be monitored when defining unavailable S-SSB periods.

In some aspects, the SyncRef UE may be a first SyncRef UE, and the UE may detect a second SyncRef UE within a time period when the measurement associated with the SLSS received from the first SyncRef UE satisfies a condition. The UE may be permitted to drop a maximum percentage of SLSS transmissions of the UE during the time period for the purpose of the detection of the second SyncRef UE, and then for the selection/reselection to the second SyncRef UE. The time period may be based at least in part on a number of detection windows with at least one unavailable S-SSB period in three S-SSB periods for S-SSB detection, and the three S-SSB periods may be selected in a detection window based at least in part on the UE implementation.

In some aspects, the UE may drop the data transmission when searching for the new detectable SyncRef UE. The UE may search additional S-SSB candidate locations for detecting a new SyncRef UE when the SyncRef UE (e.g., a current synchronization reference source) has a relatively low signal quality, which may achieve a better tradeoff between synchronization and data transmission. The SyncRef UE may be associated with the relatively low signal quality based at least in part on a PSBCH-RSRP associated with the SyncRef UE not satisfying the first threshold (e.g., the PSBCH-RSRP may be less than the first threshold). The SyncRef UE may be associated with the relatively low signal quality based at least in part on the quantity of unavailable S-SSB periods satisfying the second threshold. The UE may be required to search the additional S-SSB candidate locations for detecting the new SyncRef UE only when the current synchronization reference source has the relatively low signal quality.

In some aspects, when the SyncRef UE has the relatively low signal quality, the UE may search z additional S-SSB candidate locations. Otherwise, when the SyncRef UE (e.g., the current synchronization reference source) does not have the relatively low signal quality, the UE may not search the z additional S-SSB candidate locations. In other words, the UE may be required to search the z additional S-SSB candidate locations. Otherwise, the UE may not be required to search any additional S-SSB candidate locations. An unavailable S-SSB period may be based at least in part on whether the SLSS is available within the additional S-SSB candidate locations searched by the UE (e.g., additional S-SSB candidate locations the UE are required to search). When the UE searches the additional S-SSB candidate locations (e.g., the UE is required to search the additional S-SSB candidate locations), the UE may drop V2X sidelink data transmissions on such additional S-SSB candidate locations.

In some aspects, GNSS may be associated with a highest priority, as compared to a network node. When a synchronization source is an SyncRef UE synced directly or indirectly to GNSS, a search for a synchronous SyncRef UE may be performed. The synchronous SyncRef UE may be synced directly or indirectly to GNSS. When the synchronization source is other SyncRef UEs, a search for an asynchronous SyncRef UE may be performed. The asynchronous SyncRef UE may not be synced directly or indirectly to GNSS. In some aspects, the network node may be associated with the highest priority, as compared to the GNSS. In this case, a search for an asynchronous SyncRef UE may always be performed.

In some aspects, the search for the synchronous SyncRef UE may be based at least in part on the UE searching for the synchronous SyncRef UE at possible SLSS transmission locations in a time domain according to a timing of the UE. SLSS transmissions may be potentially dropped because the SLSS transmissions and data may be transmitted at different locations in the time domain. When searching for the synchronous SyncRef UE, the UE (e.g., a sidelink UE) may search for a new SyncRef UE at the possible SLSS transmission locations in the time domain based at least in part on its timing. Therefore, only SLSS transmissions may be dropped because SLSS and data may be transmitted at different locations in the time domain. In some aspects, the search for the asynchronous SyncRef UE may be based at least in part on the UE searching for the asynchronous SyncRef UE at an entire S-SSB period, and the asynchronous SyncRef UE may be associated with a different timing, as compared to the UE, leading to a data transmission dropping. When searching for the asynchronous SyncRef UE, the UE may search for a new SyncRef UE at an entire 160 ms S-SSB period (since the new SyncRef UE may have a different timing with the UE, which may lead to the data transmission dropping).

In some aspects, a detection time requirement for asynchronous SyncRef UEs may extend for another 8 seconds whenever an S-SSB period is unavailable in a 480 ms search window. The detection time requirement may become 8 seconds plus x*8 seconds (e.g., 8 s+x*8 s), where x is the number of 480 ms search windows, each in an 8 second period, with at least one unavailable S-SSB period. The locations of the 480 ms search windows may be based at least in part on a UE implementation. Further, x may be subject to a maximum value constraint. Common sidelink scenarios may include indoor application scenarios without GNSS access, in which case a search for an asynchronous SyncRef UE may be performed. A resulting search time may be relatively long (e.g., up to 8 seconds plus x*8 seconds). A search for asynchronous SyncRef UEs may include a search for synchronous SyncRef UEs, but an associated search time may be longer.

In some aspects, a search for the synchronous SyncRef UE may be enabled for multiple scenarios for SL-U to speed up the detection of synchronous SyncRef UEs. For example, the search for the synchronous SyncRef UE may be enabled when GNSS is the highest priority, and when the synchronization source is other SyncRef UEs and the search for the asynchronous SyncRef UE is performed. As another example, the search for the synchronous SyncRef UE may be enabled when the network node is the highest priority, and the search for the asynchronous SyncRef UE is performed. The search for the synchronous SyncRef UE may be in addition to the search for the asynchronous SyncRef UE. No additional data transmission drop may be allowed, but an additional SLSS transmission drop may be allowed.

In some aspects, the UE may perform, for SL-U, a search for the synchronous SyncRef UE based at least in part the search for the asynchronous SyncRef being performed. The search for the asynchronous SyncRef may be performed due to the synchronization source not being synced directly or indirectly to the GNSS. In some aspects, the UE may (e.g., conditionally) run the synchronous SyncRef UE search regardless of a type and/or a priority of its synchronization source. For example, the search for synchronous SyncRef UEs may be enabled for the multiple scenarios, for SL-U, which may speed up the detection of the synchronous SyncRef UEs. In other words, the UE may perform the search for the synchronous SyncRef UE regardless of the type or the priority of the synchronization source associated with the UE.

In some aspects, the UE may speed up an asynchronous/synchronous SyncRef UE search when the UE does not have a reliable/good signal quality with the SyncRef UE as the synchronization source. In some aspects, when the SyncRef UE is not available or an RSRP of the current synchronization source is relatively low, the UE may speed up the asynchronous SyncRef UE search and/or enable or speed up the synchronous SyncRef UE search. For the asynchronous SyncRef UE, the UE may increase a data transmission dropping rate to y1% and reduce a search time to 480 ms/y1% (e.g., 30% with a search time of 1.6 s). For the synchronous SyncRef UE search, the UE may enable or increase an SLSS Tx dropping rate to y2% and reduce the search time to 480 ms/y2% (e.g., 50% with a search time of 0.96 s).

In some aspects, when no detected SyncRef UE is available, or when the RSRP of the current SyncRef UE as the synchronization source is lower than a threshold of z, the UE may perform one of the following operations: enable the synchronous SyncRef UE search, enable and speed up the synchronous SyncRef UE search, enable the synchronous SyncRef UE search and speed up the asynchronous SyncRef UE search, or enable the synchronous SyncRef UE search and speed up both the asynchronous SyncRef UE search and the synchronous SyncRef UE search. The UE may perform one of the operations when GNSS is the highest priority, and when the synchronization source is other SyncRef UEs and the search for the asynchronous SyncRef UE is performed. The UE may perform one of the operations when the network node is the highest priority, and the search for the asynchronous SyncRef UE is performed.

In some aspects, the UE may perform an operation based at least in part on the SyncRef UE not being available or the measurement of the current synchronization source satisfying the threshold. The UE, when performing the operation, may enable a synchronous SyncRef UE search. The UE, when performing the operation, may enable and speed up the synchronous SyncRef UE search. The UE, when performing the operation, may enable the synchronous SyncRef UE search and speed up an asynchronous SyncRef UE search. The UE, when performing the operation, may enable the synchronous SyncRef UE search, and speed up the synchronous SyncRef UE search and the asynchronous SyncRef UE search. The UE may speed up the synchronous SyncRef UE search or the asynchronous SyncRef UE search based at least in part on an adjustment to the transmission dropping rate or an adjustment to the search time.

As indicated above, FIG. 4 is provided as an example. Other examples may differ from what is described with regard to FIG. 4.

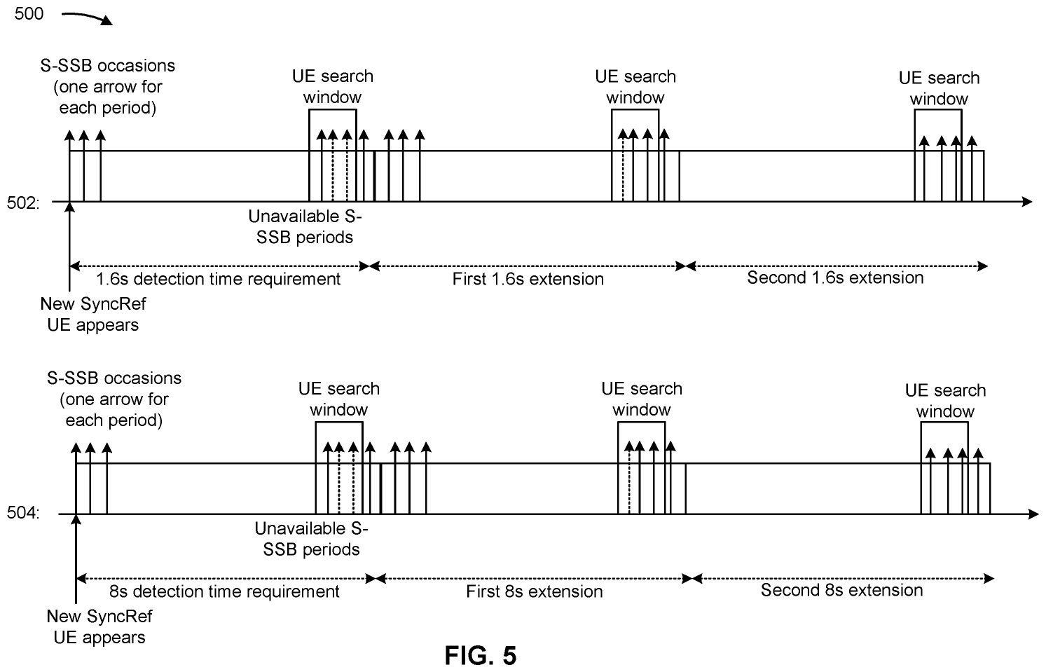

FIG. 5 is a diagram illustrating an example 500 associated with measurement evaluation periods for SLSSs from synchronization reference sources, in accordance with the present disclosure.

In some aspects, a UE may search for a new detectable SyncRef UE with unavailable S-SSB periods. The UE may be able to identify a newly detectable intra-frequency SyncRef UE within (1.6+1.6*x) seconds when an S-SSB Ês/Iot≥0 dB, provided that the UE is allowed to drop a maximum of 30% of its SLSS transmissions during the (1.6+1.6*x) seconds for the purpose of selection or reselection to the SyncRef UE. The value x may be the number of 1.6 second detection windows with at least one unavailable S-SSB period in three selected S-SSB periods for S-SSB detection, and a selection associated with the three S-SSB periods in the 1.6 second detection window may be based at least in part on a UE implementation.

As by reference number 502, an S-SSB occasion may be associated with a 1.6 second detection time, which may be associated with ten S-SSB periods. A UE search window within the SSB occasion may be for three S-SSB periods, where some of the three-SSB periods may be unavailable S-SSB periods (e.g., due to LBT failure). In that case, a first extension may be applied. The first extension may be a first 1.6 second extension. A UE search window may be associated with the first 1.6 second extension. The UE search window within the first extension may be for three S-SSB periods, where some of the three-SSB periods may be unavailable S-SSB periods (e.g., due to LBT failure). In that case, a second extension may be applied. The second extension may be a second 1.6 second extension. A UE search window may be associated with the second 1.6 second extension. The UE search window within the second extension may be for three S-SSB periods, and in this case, the UE search window may not be associated with any unavailable S-SSB periods.

As by reference number 504, an S-SSB occasion may be associated with a 8 second detection time, which may be associated with ten S-SSB periods. A UE search window within the SSB occasion may be for three S-SSB periods, where some of the three-SSB periods may be unavailable S-SSB periods (e.g., due to LBT failure). In that case, a first extension may be applied. The first extension may be a first 8 second extension. A UE search window may be associated with the first 8 second extension. The UE search window within the first extension may be for three S-SSB periods, where some of the three-SSB periods may be unavailable S-SSB periods (e.g., due to LBT failure). In that case, a second extension may be applied. The second extension may be a second 8 second extension. A UE search window may be associated with the second 8 second extension. The UE search window within the second extension may be for three S-SSB periods, and in this case, the UE search window may not be associated with any unavailable S-SSB periods.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with measurement evaluation periods for SLSSs from synchronization reference sources.

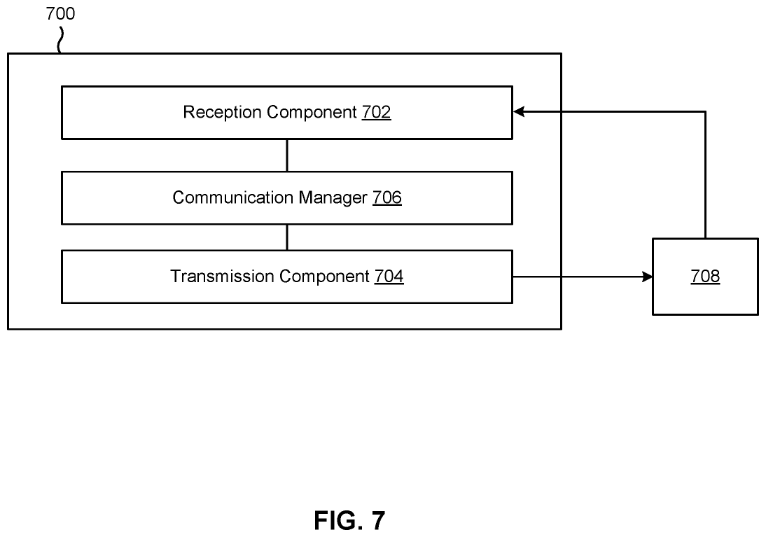

As shown in FIG. 6, in some aspects, process 600 may include determining whether an SLSS is received from a SyncRef UE during a measurement evaluation period, the measurement evaluation period being based at least in part on a quantity of S-SSB periods in which the SLSS from the SyncRef UE is not available (block 610). For example, the UE (e.g., using communication manager 706, depicted in FIG. 7) may determine whether an SLSS is received from a SyncRef UE during a measurement evaluation period, the measurement evaluation period being based at least in part on a quantity of S-SSB periods in which the SLSS from the SyncRef UE is not available, as described above.

As further shown in FIG. 6, in some aspects, process 600 may include performing an initiation or a cease of an SLSS transmission of the UE based at least in part on whether the SLSS is received from SyncRef UE during the measurement evaluation period (block 620). For example, the UE (e.g., using communication manager 706, depicted in FIG. 7) may perform an initiation or a cease of an SLSS transmission of the UE based at least in part on whether the SLSS is received from SyncRef UE during the measurement evaluation period, as described above.

Process 600 may include additional aspects, such as any single aspect or any combination of aspects described below and/or in connection with one or more other processes described elsewhere herein.

In a first aspect, the measurement evaluation period corresponds to a default quantity of S-SSB periods plus the quantity of S-SSB periods in which the SLSS from the SyncRef UE is not available.

In a second aspect, alone or in combination with the first aspect, the SLSS from the SyncRef UE is not available based at least in part on an LBT failure associated with the SyncRef UE.

In a third aspect, alone or in combination with one or more of the first and second aspects, the quantity of S-SSB periods in which the SLSS from the SyncRef UE is not available is associated with a maximum quantity, and the maximum quantity is a fixed value or is configured via RRC signaling from a network node.

In a fourth aspect, alone or in combination with one or more of the first through third aspects, the SLSS is received from the SyncRef UE during the measurement evaluation period, and the initiation or the cease of the SLSS transmission of the UE is based at least in part on a measurement associated with the SLSS received from the SyncRef UE.

In a fifth aspect, alone or in combination with one or more of the first through fourth aspects, the SLSS is not received from the SyncRef UE during the measurement evaluation period, and the initiation of the SLSS transmission of the UE is based at least in part on the SLSS not being received from the SyncRef UE during the measurement evaluation period.

In a sixth aspect, alone or in combination with one or more of the first through fifth aspects, the initiation of the SLSS transmission of the UE is based at least in part on the SyncRef UE is available as a current synchronization source for the UE.

In a seventh aspect, alone or in combination with one or more of the first through sixth aspects, the SyncRef UE is a first SyncRef UE, and process 600 includes detecting a second SyncRef UE within a time period when a measurement associated with the SLSS received from the first SyncRef UE satisfies a condition, and the UE is permitted to drop a maximum percentage of SLSS transmissions of the UE during the time period for a purpose of a detection of the second SyncRef UE, and for a selection or a reselection to the second SyncRef UE.

In an eighth aspect, alone or in combination with one or more of the first through seventh aspects, the time period and the maximum percentage are based at least in part on the quantity of S-SSB periods in which the SLSS from the SyncRef UE is not available, and the maximum percentage is associated with a maximum dropping rate constraint.

In a ninth aspect, alone or in combination with one or more of the first through eighth aspects, the time period is based at least in part on a number of detection windows with at least one unavailable S-SSB period in three S-SSB periods for S-SSB detection, and the three S-SSB periods are selected in a detection window based at least in part on a UE implementation.

In a tenth aspect, alone or in combination with one or more of the first through ninth aspects, process 600 includes searching additional S-SSB candidate locations for detecting the second SyncRef UE based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold.

In an eleventh aspect, alone or in combination with one or more of the first through tenth aspects, process 600 includes dropping data transmissions associated with the additional S-SSB candidate locations.

In a twelfth aspect, alone or in combination with one or more of the first through eleventh aspects, additional S-SSB candidate locations are not searched based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold.

In a thirteenth aspect, alone or in combination with one or more of the first through twelfth aspects, process 600 includes performing, for an SL-U, a search for a synchronous SyncRef UE based at least in part a search for an asynchronous SyncRef being performed.

In a fourteenth aspect, alone or in combination with one or more of the first through thirteenth aspects, the search for the asynchronous SyncRef is performed due to a synchronization source not being synced directly or indirectly to a GNSS.

In a fifteenth aspect, alone or in combination with one or more of the first through fourteenth aspects, the search for the synchronous SyncRef UE is based at least in part on the UE searching for the synchronous SyncRef UE at possible SLSS transmission locations in a time domain according to a timing of the UE, and SLSS transmissions are potentially dropped because the SLSS transmissions and data are transmitted at different locations in the time domain.

In a sixteenth aspect, alone or in combination with one or more of the first through fifteenth aspects, the search for the asynchronous SyncRef UE is based at least in part on the UE searching for the asynchronous SyncRef UE at an entire S-SSB period, and the asynchronous SyncRef UE is associated with a different timing, as compared to the UE, leading to a data transmission dropping.

In a seventeenth aspect, alone or in combination with one or more of the first through sixteenth aspects, process 600 includes performing a search for a synchronous SyncRef UE regardless of a type or a priority of a synchronization source associated with the UE.

In an eighteenth aspect, alone or in combination with one or more of the first through seventeenth aspects, process 600 includes performing an operation based at least in part on the SyncRef UE not being available or a measurement of a current synchronization source satisfying a threshold.

In a nineteenth aspect, alone or in combination with one or more of the first through eighteenth aspects, process 600 includes: enabling a synchronous SyncRef UE search; enabling and speeding up the synchronous SyncRef UE search; enabling the synchronous SyncRef UE search and speeding up an asynchronous SyncRef UE search; or enabling the synchronous SyncRef UE search, and speeding up the synchronous SyncRef UE search and the asynchronous SyncRef UE search, and speeding up the synchronous SyncRef UE search or the asynchronous SyncRef UE search is based at least in part on an adjustment to a transmission dropping rate or an adjustment to a search time.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 4-5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may determine whether an SLSS is received from a SyncRef UE during a measurement evaluation period, the measurement evaluation period being based at least in part on a quantity of S-SSB periods in which the SLSS from the SyncRef UE is not available. The communication manager 706 may perform an initiation or a cease of an SLSS transmission of the UE based at least in part on whether the SLSS is received from SyncRef UE during the measurement evaluation period.

The communication manager 706 may detect a second SyncRef UE within a time period when a measurement associated with the SLSS received from a first SyncRef UE satisfies a condition, and the UE is permitted to drop a maximum percentage of SLSS transmissions of the UE during the time period for a purpose of a detection of the second SyncRef UE, and for a selection or a reselection to the second SyncRef UE. The communication manager 706 may search additional S-SSB candidate locations for detecting the second SyncRef UE based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold. The communication manager 706 may drop data transmissions associated with the additional S-SSB candidate locations.

The communication manager 706 may perform, for an SL-U, a search for a synchronous SyncRef UE based at least in part a search for an asynchronous SyncRef being performed. The communication manager 706 may perform a search for a synchronous SyncRef UE regardless of a type or a priority of a synchronization source associated with the UE. The communication manager 706 may perform an operation based at least in part on the SyncRef UE not being available or a measurement of a current synchronization source satisfying a threshold. The communication manager 706 may enable a synchronous SyncRef UE search. The communication manager 706 may enable and speed up the synchronous SyncRef UE search. The communication manager 706 may enable the synchronous SyncRef UE search and speed up an asynchronous SyncRef UE search. The communication manager 706 may enable the synchronous SyncRef UE search, and speed up the synchronous SyncRef UE search and the asynchronous SyncRef UE search.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: determining whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available; and performing an initiation or a cease of an SLSS transmission of the UE based at least in part on whether the SLSS is received from SyncRef UE during the measurement evaluation period.

Aspect 2: The method of Aspect 1, wherein the measurement evaluation period corresponds to a default quantity of S-SSB periods plus the quantity of S-SSB periods in which the SLSS from the SyncRef UE is not available.

Aspect 3: The method of any of Aspects 1-2, wherein the SLSS from the SyncRef UE is not available based at least in part on a listen-before-talk (LBT) failure associated with the SyncRef UE.

Aspect 4: The method of any of Aspects 1-3, wherein the quantity of S-SSB periods in which the SLSS from the SyncRef UE is not available is associated with a maximum quantity, and the maximum quantity is a fixed value or is configured via radio resource control (RRC) signaling from a network node.

Aspect 5: The method of any of Aspects 1-4, wherein the SLSS is received from the SyncRef UE during the measurement evaluation period, and the initiation or the cease of the SLSS transmission of the UE is based at least in part on a measurement associated with the SLSS received from the SyncRef UE.

Aspect 6: The method of any of Aspects 1-5, wherein the SLSS is not received from the SyncRef UE during the measurement evaluation period, and the initiation of the SLSS transmission of the UE is based at least in part on the SLSS not being received from the SyncRef UE during the measurement evaluation period.

Aspect 7: The method of Aspect 6, wherein the initiation of the SLSS transmission of the UE is based at least in part on the SyncRef UE is available as a current synchronization source for the UE.

Aspect 8: The method of any of Aspects 1-7, wherein the SyncRef UE is a first SyncRef UE, and further comprising: detecting a second SyncRef UE within a time period when a measurement associated with the SLSS received from the first SyncRef UE satisfies a condition, and the UE is permitted to drop a maximum percentage of SLSS transmissions of the UE during the time period for a purpose of a detection of the second SyncRef UE, and for a selection or a reselection to the second SyncRef UE.

Aspect 9: The method of Aspect 8, wherein the time period and the maximum percentage are based at least in part on the quantity of S-SSB periods in which the SLSS from the SyncRef UE is not available, and the maximum percentage is associated with a maximum dropping rate constraint.

Aspect 10: The method of Aspect 8, wherein the time period is based at least in part on a number of detection windows with at least one unavailable S-SSB period in three S-SSB periods for S-SSB detection, and the three S-SSB periods are selected in a detection window based at least in part on a UE implementation.

Aspect 11: The method of Aspect 8, further comprising: searching additional S-SSB candidate locations for detecting the second SyncRef UE based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold.

Aspect 12: The method of Aspect 11, further comprising: dropping data transmissions associated with the additional S-SSB candidate locations.

Aspect 13: The method of Aspect 8, wherein additional S-SSB candidate locations are not searched based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold.

Aspect 14: The method of any of Aspects 1-13, further comprising: performing, for a sidelink unlicensed (SL-U), a search for a synchronous SyncRef UE based at least in part a search for an asynchronous SyncRef being performed.

Aspect 15: The method of Aspect 14, wherein the search for the asynchronous SyncRef is performed due to a synchronization source not being synced directly or indirectly to a global navigation satellite system (GNSS).

Aspect 16: The method of Aspect 14, wherein the search for the synchronous SyncRef UE is based at least in part on the UE searching for the synchronous SyncRef UE at possible SLSS transmission locations in a time domain according to a timing of the UE, and SLSS transmissions are potentially dropped because the SLSS transmissions and data are transmitted at different locations in the time domain.

Aspect 17: The method of Aspect 14, wherein the search for the asynchronous SyncRef UE is based at least in part on the UE searching for the asynchronous SyncRef UE at an entire S-SSB period, and the asynchronous SyncRef UE is associated with a different timing, as compared to the UE, leading to a data transmission dropping.

Aspect 18: The method of any of Aspects 1-17, performing a search for a synchronous SyncRef UE regardless of a type or a priority of a synchronization source associated with the UE.

Aspect 19: The method of any of Aspects 1-18, performing an operation based at least in part on the SyncRef UE not being available or a measurement of a current synchronization source satisfying a threshold.

Aspect 20: The method of Aspect 19, wherein performing the operation comprises: enabling a synchronous SyncRef UE search; enabling and speeding up the synchronous SyncRef UE search; enabling the synchronous SyncRef UE search and speeding up an asynchronous SyncRef UE search; or enabling the synchronous SyncRef UE search, and speeding up the synchronous SyncRef UE search and the asynchronous SyncRef UE search, wherein speeding up the synchronous SyncRef UE search or the asynchronous SyncRef UE search is based at least in part on an adjustment to a transmission dropping rate or an adjustment to a search time.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “of” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, which, individually or in any combination, are operable to cause the apparatus to:
determine whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available; and
perform an initiation or a cease of an SLSS transmission of the UE based at least in part on whether the SLSS is received from SyncRef UE during the measurement evaluation period.

2. The apparatus of claim 1, wherein the measurement evaluation period corresponds to a default quantity of S-SSB periods plus the quantity of S-SSB periods in which the SLSS from the SyncRef UE is not available.

3. The apparatus of claim 1, wherein the SLSS from the SyncRef UE is not available based at least in part on a listen-before-talk (LBT) failure associated with the SyncRef UE.

4. The apparatus of claim 1, wherein the quantity of S-SSB periods in which the SLSS from the SyncRef UE is not available is associated with a maximum quantity, and the maximum quantity is a fixed value or is configured via radio resource control (RRC) signaling from a network node.

5. The apparatus of claim 1, wherein the SLSS is received from the SyncRef UE during the measurement evaluation period, and the initiation or the cease of the SLSS transmission of the UE is based at least in part on a measurement associated with the SLSS received from the SyncRef UE.

6. The apparatus of claim 1, wherein the SLSS is not received from the SyncRef UE during the measurement evaluation period, and the initiation of the SLSS transmission of the UE is based at least in part on the SLSS not being received from the SyncRef UE during the measurement evaluation period, wherein the initiation of the SLSS transmission of the UE is based at least in part on the SyncRef UE being available as a current synchronization source for the UE.

7. The apparatus of claim 1, wherein the SyncRef UE is a first SyncRef UE, and the one or more processors are configured to:
detect a second SyncRef UE within a time period when a measurement associated with the SLSS received from the first SyncRef UE satisfies a condition, and the UE is permitted to drop a maximum percentage of SLSS transmissions of the UE during the time period for a purpose of a detection of the second SyncRef UE, and for a selection or a reselection to the second SyncRef UE.

8. The apparatus of claim 7, wherein the time period and the maximum percentage are based at least in part on the quantity of S-SSB periods in which the SLSS from the SyncRef UE is not available, and the maximum percentage is associated with a maximum dropping rate constraint.

9. The apparatus of claim 7, wherein the time period is based at least in part on a number of detection windows with at least one unavailable S-SSB period in three S-SSB periods for S-SSB detection, and the three S-SSB periods are selected in a detection window based at least in part on a UE implementation.

10. The apparatus of claim 7, wherein the one or more processors are configured to:
search additional S-SSB candidate locations for detecting the second SyncRef UE based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold; and
drop data transmissions associated with the additional S-SSB candidate locations.

11. The apparatus of claim 7, wherein additional S-SSB candidate locations are not searched based at least in part on a signal quality associated with the SLSS received from the first SyncRef UE, and the signal quality is based at least in part on the SLSS being associated with a measurement that satisfies a first threshold, or the signal quality is based at least in part on the quantity of S-SSB periods in which the SLSS from the SyncRef UE is not available satisfying a second threshold.

12. The apparatus of claim 1, wherein the one or more processors are configured to:
perform, for a sidelink unlicensed (SL-U), a search for a synchronous SyncRef UE based at least in part a search for an asynchronous SyncRef UE being performed.

13. The apparatus of claim 12, wherein the search for the asynchronous SyncRef UE is performed due to a synchronization source not being synced directly or indirectly to a global navigation satellite system (GNSS).

14. The apparatus of claim 12, wherein the search for the synchronous SyncRef UE is based at least in part on the UE searching for the synchronous SyncRef UE at possible SLSS transmission locations in a time domain according to a timing of the UE, and SLSS transmissions are potentially dropped because the SLSS transmissions and data are transmitted at different locations in the time domain.

15. The apparatus of claim 12, wherein the search for the asynchronous SyncRef UE is based at least in part on the UE searching for the asynchronous SyncRef UE at an entire S-SSB period, and the asynchronous SyncRef UE is associated with a different timing, as compared to the UE, leading to a data transmission dropping.

16. The apparatus of claim 1, wherein the one or more processors are configured to:
perform a search for a synchronous SyncRef UE regardless of a type or a priority of a synchronization source associated with the UE.

17. The apparatus of claim 1, wherein the one or more processors are configured to:
perform an operation based at least in part on the SyncRef UE not being available or a measurement of a current synchronization source satisfying a threshold.

18. The apparatus of claim 17, wherein the one or more processors, when performing the operation, are configured to:
enable a synchronous SyncRef UE search;
enable and speed up the synchronous SyncRef UE search;
enable the synchronous SyncRef UE search and speed up an asynchronous SyncRef UE search; or
enable the synchronous SyncRef UE search, and speed up the synchronous SyncRef UE search and the asynchronous SyncRef UE search,
wherein speeding up the synchronous SyncRef UE search or the asynchronous SyncRef UE search is based at least in part on an adjustment to a transmission dropping rate or an adjustment to a search time.

19. A method of wireless communication performed by a user equipment (UE), comprising:
determining whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available; and
performing an initiation or a cease of an SLSS transmission of the UE based at least in part on whether the SLSS is received from SyncRef UE during the measurement evaluation period.

20. A non-transitory computer-readable medium storing a set of instructions for wireless communication, the set of instructions comprising:
one or more instructions that, when executed by one or more processors of a user equipment (UE), cause the UE to:
determine whether a sidelink synchronization signal (SLSS) is received from a synchronization reference (SyncRef) UE during a measurement evaluation period, the measurement evaluation period being based at least in part on a quantity of sidelink synchronization signal block (S-SSB) periods in which the SLSS from the SyncRef UE is not available; and
perform an initiation or a cease of an SLSS transmission of the UE based at least in part on whether the SLSS is received from SyncRef UE during the measurement evaluation period.
